(19) United States
(12) Patent Application Publication
(10) Pub. No.: US 2005/0261469 A1
(43) Pub. Date: Nov. 24, 2005

(54) High performance polymer electrolyte with improved thermal and chemical characteristics

(76) Inventors: Gangadhar Panambur, Honolulu, HI (US); Rameshkumar Chellappan, Honolulu, HI (US)

Correspondence Address: Dechert LLP, P.O. Box 10004, Palo Alto, CA, 94303, US

(21) Appl. No.: 10/851,414

(22) Filed: May 21, 2004

(51) Int. Cl. H01M 8/04

(52) U.S. Cl. 528/425

(57) ABSTRACT

A novel monomer composition and a process of synthesizing the novel monomer is described. Generally, such novel monomers have an aliphatic spacer unit between two phenyl rings. In one embodiment the inventive monomer has a general structure of: 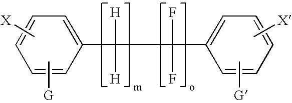 wherein X and X′ independently include a functional group selected from the group consisting of hydroxy, halogen, nitro, carboxylic acid, trimethylsiloxy and amines; G and G′ independently include one selected from the group consisting of hydrogen, sulfonic acid, phosphoric acid, carboxylic acid, sulfonamide, and imidazole; “m” and “o” being integers and each independently having a value in the range from 0 to 15. The aliphatic spacer unit in alternative described embodiments of the inventive monomer does not contain the fluorinated methylene unit. Novel processes of synthesizing such monomers are also described. Based on these inventive monomer compositions, inventive polymer structures and processes of synthesizing them are also described.

### FIELD OF THE INVENTION

The present invention relates to a high performance polymer. More particularly, the present invention relates to polymers, which include a novel monomer and a high yield method for synthesizing the same. The polymer of the present invention has improved thermal, chemical, and physical properties that make it useful in fuel cell applications, especially as an electrolyte.

### BACKGROUND OF THE INVENTION

With the growing need for energy in the presence of limited fossil fuel supply, the demand for environmentally friendly and renewable energy sources is increasing. Fuel cell technology, a promising source of clean energy production, is leading candidate to meet the growing need for energy. Fuel cells are efficient energy generating devices that are quiet during operation, fuel flexible (i.e., have the potential to use multiple fuel sources), and have co-generative capabilities (i.e., can produce electricity and usable heat, which may ultimately be converted to electricity). Of the various fuel cell types, the proton exchange membrane fuel cell (PEMFC) has the greatest potential. PEMFCs can be used for energy applications spanning the stationary, portable electronic equipment and automotive markets.

At the heart of the PEMFC is a fuel cell membrane (hereinafter “proton exchange membrane”), which separates the anode and cathode compartments of the fuel cell. The proton exchange membrane controls the performance, efficiency, and other major operational characteristics of the fuel cell. As a result, the membrane should be an effective gas separator, effective ion conducting electrolyte, have a high proton conductivity in order to meet the energy demands of the fuel cell, and have a stable structure to support long fuel cell operational lifetimes. Moreover, the material used to form the membrane should be physically and chemically stable enough to allow for different fuel sources and a variety of operational conditions.

Currently, many fuel cell membranes are formed from perfluorinated sulfonic acid (PFSA) materials. A commonly known PFSA membrane is Nafion® and is commercially available from DuPont.

Nafion® and other similar perfluorinated membrane materials manufactured by companies such as W. L. Gore and Asahi Glass (described in U.S. Pat. Nos. 6,287,717 and 6,660,818 respectively) show high oxidative stability as well as good performance when used with pure hydrogen fuel. Unfortunately, these perfluorinated membrane materials are expensive and have poor characteristics such as high methanol crossover, which must be overcome for viable fuel cell operation and commercialization.

Making perfluorinated ionomer materials require complex monomer and polymerization reactions. These reactions are often time consuming, hazardous, and low yielding. Furthermore, these reactions are cost prohibitive, i.e., currently contribute to the costs as much as about $500 per m².

Methanol, a hydrogen rich molecule, is a promising fuel for PEMFCs. Specifically, methanol's low cost, and high energy density make it a viable hydrogen fuel source for PEMFCs. Methanol provides the fuel cell technology with significant market potential in portable and automotive electronic equipment applications. Methanol is typically introduced in its liquid state. Unfortunately, the physical and chemical structure of Nafion® and other Nafion®-like materials allows for significant methanol crossover. Such cross over effectively reduces fuel cell performance by partially shorting the chemical potential of the fuel cell.

To overcome these cost and performance limitations, alternative polymer materials, such as poly(benzimidazole) (PBI), polyvinylidene fluoride (PVDF), styrene based co-polymers, and aromatic thermoplastics have been actively researched. To date, the most promising of these alternative materials has been acid functionalized aromatic thermoplastics.

Aromatic thermoplastics such as poly(ether ether ketone) (PEEK), poly(ether ketone) (PEK), poly(sulfone) (PSU), poly(ether sulfone) (PES), are promising candidates as fuel cell membranes due to their low cost, high mechanical strength, and good film forming characteristics. When functionalized with sulfonic acid groups, these materials have exhibited acceptable fuel cell performance and low methanol crossover.

Additionally, the high thermal stability of these membranes has made them potential candidates for medium temperature PEMFC operation. However, the aromatic structure of these thermoplastics, which contribute to their high thermal stability, have shown one significant challenge. The rigid structure of these thermoplastic materials has led to processing difficulties when constructing the membrane electrode assembly (“MEA”). Specifically, regardless of the technique (i.e., spraying, decaling, sputtering, and printing) implemented, the membrane electrode assembly's construction suffers from significant adhesion problems at the electrode-membrane interface.

The difficulty in processing thermoplastic based MEAs in fuel cells is mainly attributed to the high glass transition temperature (“Tg”) of these aromatic materials. Tgs make membrane electrode assembly processing extremely difficult because traditional MEA hot press conditions typically occur below the Tg of these materials. If the electrodes are not adhered to the polymer membrane, the performance of the material is limited in fuel cell operation due to resistance at membrane electrode interface. Alternatively, if these aromatic thermoplastics are hot-pressed above or at their Tg, many of these compounds will start to desulfonate or decompose, rendering them less effective as a fuel cell membrane.

Unfortunately, the rigid structure and resulting thermal properties of these materials continue to cause limited MEA adhesion and lower fuel cell performance in certain instances. What is therefore needed is an improved MEA, which is cost effective, high performing, easily processed and contains no adhesion problems.

### SUMMARY OF THE INVENTION

To achieve the foregoing, the present invention provides a MEA, which is economical, high performing, easily processed and does not suffer from adhesion problems. The MEA is at least partially made from an inventive polymer, which in turn includes an inventive monomer repeat unit.

A monomer composition, according to one embodiment of the present invention, has at least one aliphatic spacer unit located between two phenyl rings. In one embodiment, the monomer of the present invention has the following structure: 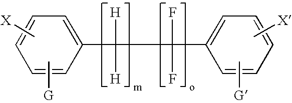
In this embodiment, X and X′ independently include a functional group selected from the group consisting of hydroxy, halogen, nitro, carboxylic acid, trimethylsiloxy and amines. G and G′ independently include one member selected from the group consisting of hydrogen, sulfonic acid, phosphoric acid, carboxylic acid, sulfonamide and imidazole. Furthermore, G and G′ may be fluorinated or nonfluorinated aliphatic chains containing one or more of the aforementioned group compounds. Integer “m” has a value in a range from 0 to 15 and integer “o” has a value in a range from 1 to 15.

In alternative embodiments, the inventive monomer composition contains only methylene groups as an aliphatic spacer unit, without the presence of fluorinated methylene units described in the above embodiment. Representative monomer compositions of the present invention include α,ω-bis(4-hydroxyphenyl)alkane, α,ω-bis(4-hydroxyphenyl)perfluoroalkane and α,ω-bis(4-halophenyl)perfluoroalkane.

In another aspect, the present invention provides a process for synthesizing such inventive monomer compositions. For example, the process for synthesizing a α,ω-bis(4-hydroxyphenyl)alkane monomer includes the steps of: (a) converting a 1,4-disubstituted benzene to a Grignard reagent; (b) reacting the Grignard reagent with a α,ω-dihaloalkane; and (c) deprotecting the phenoxy groups in the product obtained from the previous reaction step to produce the α,ω-bis(4-hydroxyphenyl)alkane monomer.

In yet another aspect, the present invention offers polymers, which include the inventive repeat units which are derived from the inventive monomers. At a minimum, such polymers have an aliphatic spacer group located between two phenyl rings. The presence of such aliphatic spacer group allows a proton exchange membrane, which is made using the inventive polymer, to overcome the adhesion limitations encountered by the prior art membranes. Furthermore, the presence of such aliphatic spacer helps to improve proton conductivity. In one embodiment, the polymer of the present invention contains a repeat unit having a general structure: 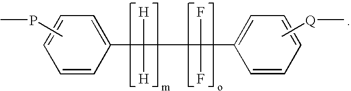
In this embodiment, P and Q independently are functional groups selected from the group consisting of ethers, sulfides, sulfones, ketones, esters, amides, imides and carbon-carbon bonds. The integer values “m” and “o” represent a number of methylene and fluorinated methylene units, respectively. These integer values range between 0 and 15 and are consistent with the above-described inventive monomers. As a result, those skilled in the art will recognize that in alternative embodiments of the inventive polymer, when integer “o” equals zero, integer “m” can equal one of 3, 4, 5, 7, 8, 9, 10, 11, 12, 13, 14, and 15.

The polymer composition in certain embodiments includes inventive repeat units that in turn contain functional groups designated as G and G′, which are one member selected from the group consisting of sulfonic acids, phosphoric acids, carboxylic acids, sulfonamides and imidazoles. Furthermore, G and G′ may be fluorinated or nonfluorinated aliphatic chains containing one or more of the aforementioned group compounds. G and G′ independently are situated on the ortho, meta, or para positions to P or Q.

In yet another aspect, the present invention provides a method of synthesizing the inventive polymers. The synthesis process includes combining monomer components, at least one of which includes an inventive monomer composition. Typically, monomer components are combined in precise stoichiometric amounts under a dry, inert atmosphere to form a polymer. The monomer components are dispersed in an solvent, which is a member selected from the group consisting of N,N-dimethylformamide (DMF), N,N-dimethyl acetamide (DMAc), N-methyl-2-pyrrolidinone (NMP), dimethyl sulfoxide (DMSO) and diphenyl sulfoxide (DPSO). Next, an azeotropic component selected from the group consisting of toluene, benzene and xylene may be added to facilitate the removal of water formed as a byproduct from the solution. In one embodiment of the present invention, the polymer is then precipitated by pouring the reaction mixture into water, organic solvent, or a mixture of water and organic solvent. The precipitated polymer can be purified in a subsequent step.

In some embodiments of the polymer synthesis process, an inorganic base is added to facilitate the reaction. The inorganic base is present in a molar ratio between about 0.75:1 and about 2.5:1. Furthermore, the inorganic base is a member selected from the group consisting of potassium carbonate, sodium carbonate, cesium carbonate, sodium hydroxide, potassium hydroxide and sodium hydride. The temperature of the polymer synthesis reaction is between about 100° C. and about 350° C. The total reaction time may be between about 2 hours and about 72 hours.

In yet another aspect, the present invention provides transparent, ductile films, which are made from the inventive polymer, derived from the inventive repeat units. Such repeat units are used to construct a polymer for use as proton exchange membranes in fuel cell applications.

### BRIEF DESCRIPTION OF THE FIGURES

FIG. 1 is a diagram of a fuel cell which has incorporated into it a MEA, according to one embodiment of the present invention.

FIG. 2 shows a side sectional view of the MEA shown in FIG. 1 and including the inventive polymer.

FIG. 3 is a flowchart of a process, in accordance with one embodiment of the present invention, of making the inventive α,ω-bis(4-hydroxyphenyl)alkane monomer.

FIG. 4 is a flowchart of a process, in accordance with an alternative embodiment of the present invention, of making the inventive α,ω-bis(4-hydroxyphenyl)alkane monomer.

FIG. 5 is a flowchart of a process, in accordance with one embodiment of the present invention, of making the inventive α,ω-bis(4-hydroxyphenyl)perfluoroalkane monomer.

FIG. 6 shows a Carbon-13 Nuclear Magnetic Resonance Spectra (“¹³C NMR”) to confirm the synthesis of the 1,4-bis(4-hydroxyphenyl)butane monomer, which is a particular species of α,ω-bis(4-hydroxyphenyl)alkane.

FIG. 7 shows an Proton Nuclear Magnetic Resonance Spectra (“¹H-NMR”), which also confirms the synthesis of the 1,4-bis(4-hydroxyphenyl)butane monomer.

FIG. 8 shows an ¹H-NMR spectra to confirm the synthesis of 1,4-bis(4-hydroxyphenyl)octafluorobutane, which is a particular species of α,ω-bis(4-hydroxyphenyl)perfluoroalkane.

FIG. 9 shows a Fluorine-19 Nuclear Magnetic Resonance Spectra (“¹⁹F NMR”) to confirm the synthesis of 1,4-bis(4-hydroxyphenyl)octafluorobutane.

FIG. 10 shows a Mass Spectra (MS) to confirm the synthesis of 1,4-bis(4-hydroxyphenyl)octafluorobutane.

FIG. 11 shows an exemplar synthesis process for producing an inventive polymer.

FIG. 12A shows another exemplar synthesis process for producing an inventive polymer.

FIG. 12B shows yet another exemplar synthesis process for producing an inventive polymer.

FIG. 13 shows yet another exemplar synthesis process for producing an inventive polymer.

FIG. 14 shows a comparative graph of the ion exchange capacities of a comparative prior art polymer and exemplar inventive polymers.

FIG. 15 shows a comparative plot of the methanol crossover for Nafion® and one embodiment of the inventive polymer.

FIG. 16 shows comparative plots of the Tgs of a comparative prior art polymer and exemplar inventive polymers.

FIG. 17 shows comparative plots of the fuel cell performance of a comparative prior art polymer and one embodiment of the inventive polymer.

### DETAILED DESCRIPTION OF THE INVENTION

The polymer of the present invention can be used as an electrolyte in electrochemical devices, such as fuel cells. In one implementation, the present invention is well suited for use as a proton exchange membrane in fuel cell applications. The proton exchange membrane prepared according to the inventive steps of the present invention has better adhesive properties, allowing for construction of higher performance MEAs than those found in the prior art.

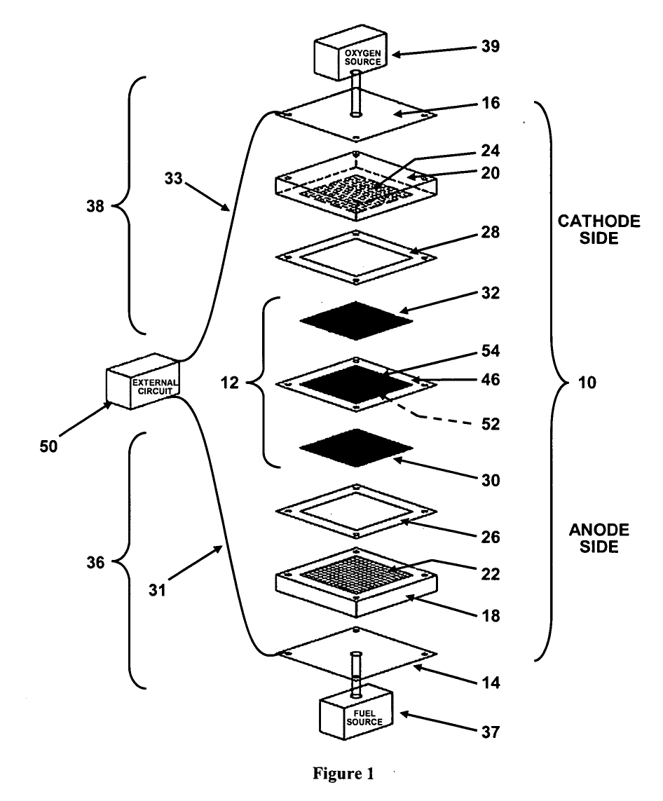

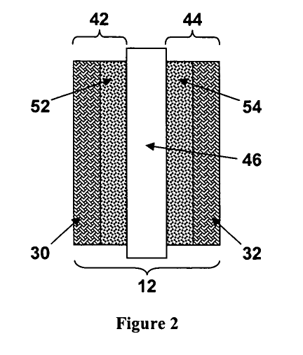

FIG. 1 shows a fuel cell 10 that has incorporated into it an MEA 12, in accordance with one embodiment of the present invention. MEA 12 includes an inventive proton exchange membrane 46, which is shown in FIG. 2 and mentioned above. It should be, however, noted that the application of inventive membranes are not limited to the fuel cell configuration shown in FIG. 1, rather they can also be effectively employed in conventional fuel cell applications described in U.S. Pat. Nos. 5,248,566 and 5,547,777, for example. Furthermore, several fuel cells may be connected in series by conventional techniques to create fuel cell stacks, which contain at least one of the inventive membranes.

As shown in FIG. 1, electrochemical cell 10 generally includes an MEA 12 flanked by anode and cathode structures. On the anode side, fuel cell 10 includes an endplate 14, graphite block or bipolar plate 18 with openings 22 to facilitate gas distribution, gasket 26, and anode gas diffusion layer (“GDL”) 30. On the cathode side, fuel cell 10 similarly includes an endplate 16, graphite block or bipolar plate 20 with openings 24 to facilitate gas distribution, gasket 28, and cathode GDL 32.

Anode end plate 14 and cathode end plate 16 are connected to external load circuit 50 by leads 31 and 33, respectively. External circuit 50 can comprise any conventional electronic device or load such as those described in U.S. Pat. Nos. 5,248,566, 5,272,017, 5,547,777, and 6,387,556, which are incorporated herein by reference for all purposes. The electrical components can be hermetically sealed by techniques well known to those skilled in the art.

During operation, in fuel cell 10 of FIG. 1, fuel from fuel source 37 (e.g., container or ampule) diffuses through the anode and oxygen from oxygen source 39 (e.g., container, ampule, or air) diffuses to the cathode of the MEA. The chemical reactions at the MEA generate electricity that is transported to the external circuit. Hydrogen fuel cells use hydrogen as the fuel and oxygen (either pure or from air) as the oxidant. For direct methanol fuel cells, the fuel is liquid methanol.

Endplates 14 and 16 are made from a relatively dimensionally stable material. Preferably, such material includes one selected from the group consisting of metal and metal alloy. Bipolar plates, 20 and 22, are typically made from any conductive material selected from the group consisting of graphite, carbon, metal and metal alloy. Gaskets, 26 and 28 are typically made of any material selected from the group consisting of Teflon, fiberglass, silicone, and rubber. GDLs, 30 and 32, are typically made from a porous electrode material such as carbon cloth or carbon paper. Furthermore, GDLs 30 and 32 may contain some sort of dispersed carbon based powder to facilitate gas movement.

FIG. 2 shows a side-sectional view of MEA 12, which is incorporated into fuel cell 10 of FIG. 1. As shown in this embodiment, MEA 12 includes a proton exchange membrane 46 that is flanked by anode 42 and cathode 44. On the anode side, MEA 12 includes a GDL 30, and some sort of catalyst dispersion 52. On the cathode side, MEA 12 similarly includes a GDL 32, and some sort of catalyst dispersion 54. Proton exchange membrane 46 is at least partially made from an inventive monomer repeat unit. Such monomer compositions and their corresponding molecular structures are described below in great detail.

In one embodiment, the inventive monomer has the following general structure 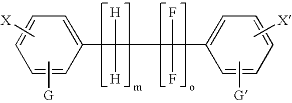
In this embodiment, X and X′ independently are a functional group selected from the group consisting of hydroxy, halogens, nitro, carboxylic acids, trimethylsiloxy (OTMS), and amines. Furthermore, X and X′ independently may be attached at any one of the ortho, meta or para positions to their corresponding aromatic ring. G and G′ are a functional group selected to facilitate proton conductivity (or performance) in hydrogen fuel cell membranes. G and G′ independently are one member selected from the group consisting of hydrogen, sulfonic acids, phosphoric acids, carboxylic acids, sulfonamides and imidazoles. Furthermore, G and G′ may be fluorinated or nonfluorinated aliphatic chains containing one or more of the aforementioned group compounds. The disclosed side chain structure of the present invention includes a proton conduction facilitator, which is thought to increase proton conductivity and also increase the overall stability of the resulting membrane.

Integer “m” is a value between 0 and 15 and represents the number of methylene units in the aliphatic spacer unit between the two aromatic rings. Integer “o” is a value between 1 and 15 and represents the number of fluorinated methylene units in the aliphatic spacer unit between the two aromatic rings. Furthermore, the order of the methylene and fluorinated methylene groups in the novel monomer may be random or specific in nature. The chain of methylene and fluorinated methylene units are referred to as the aliphatic spacer. Typical values for the sum of “m” and “o” range from 1 to 15. The aliphatic spacer unit between the phenyl rings may optionally include a functional group selected from the group consisting of carbon-based branched structures, alkenes, alkynes, ketones, sulfones, sulfates, amides and ethers.

In an alternative embodiment, the inventive monomer has the following structure 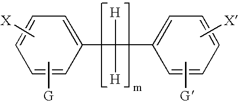
In this alternative embodiment, X and X′ independently are a functional group selected from the group consisting of hydroxy, halogens, nitro, carboxylic acids, trimethylsiloxy (OTMS), and amines. X and X′ are attached at any one of the ortho, meta or para positions to their corresponding aromatic ring. The group designated G and G′ represents an optional functional group that facilitates proton conductivity (or performance) in hydrogen fuel cell membranes. G and G′ independently are one member selected from the group consisting of hydrogen, sulfonic acids, phosphoric acids, carboxylic acids, sulfonamides and imidazoles. Furthermore, G and G′ may be fluorinated or nonfluorinated aliphatic chains containing one or more of the aforementioned group compounds. Integer “m” includes 3, 4, 5, 7, 8, 9, 10, 11, 12, 13, 14, and 15 and represents the number of methylene units in the aliphatic spacer unit between two aromatic rings. Furthermore, the aliphatic spacer unit between the phenyl rings may optionally contain a functional group selected from the group consisting of carbon-based branched structures, alkenes, alkynes, ketones, sulfones, sulfates, amides and ethers.

Table 1 below sets forth exemplar embodiments of the inventive monomer and their structures.

TABLE 1

| Monomer | Structure |
|---|---|
| α,ω-bis(4-hydroxyphenyl)alkane | 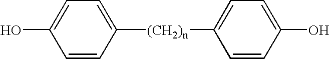 |
| α,ω-bis(4-hydroxyphenyl)perfluoroalkane | 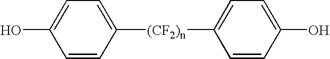 |
| α,ω-bis(4-halophenyl)perfluoroalkane | 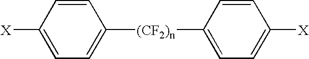 |

Referring to Table 1, the α,ω-bis(4-hydroxyphenyl)alkane incorporates an aliphatic hydrocarbon spacer between two hydroxyl functionalized phenyl rings. In the structure of α,ω-bis(4-hydroxyphenyl)alkane “n” is an integer having values 3, 4, 5, 7, 8, 9, 10, 11, 12, 13, 14, and 15. The α,ω-bis(4-halophenyl)perfluoroalkane above incorporates fully fluorinated methylene groups between the two phenyl rings. In the structure of α,ω-bis(4-halophenyl)perfluoroalkane, X may be independently of the chloride or fluoride type. Integer “n” has a value that ranges from 1 to 15. Similarly, the value of “n” in the structure of α,ω-bis(4-hydroxyphenyl)perfluoroalkane also ranges from 1 to 15. The primary difference between α,ω-bis(4-halophenyl)perfluoroalkane and α,ω-bis(4-hydroxyphenyl)perfluoroalkane is that α,ω-bis(4-halophenyl)perfluoroalkane contains halogen functionalized aromatic rings as opposed to hydroxyl functionalized aromatic rings found in α,ω-bis(4-hydroxyphenyl)perfluoroalkane.

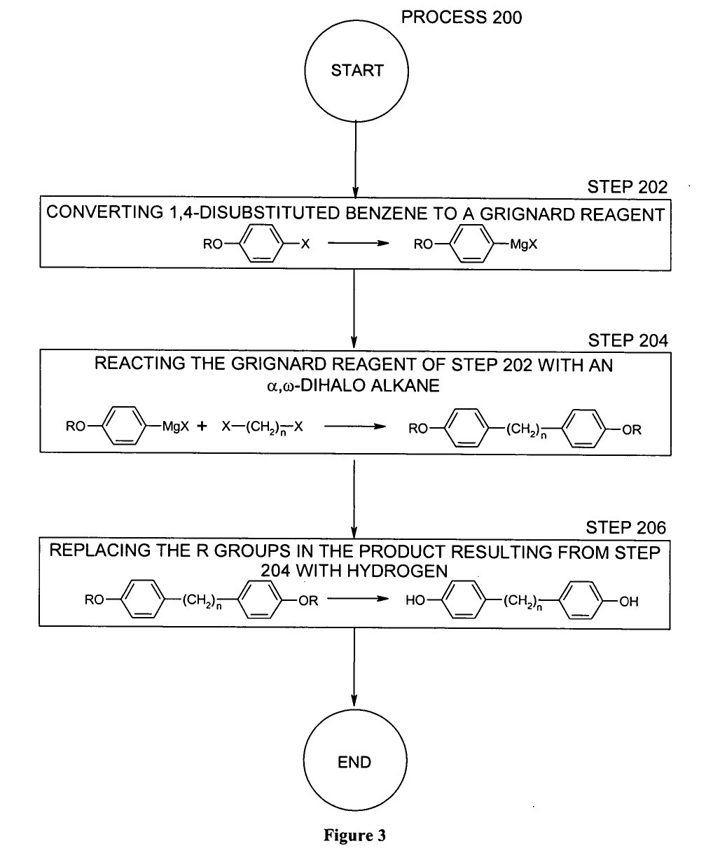

FIG. 3 is a flowchart of the significant steps involved in a process 200 of synthesizing a α,ω-bis(4-hydroxyphenyl)alkane monomer, according to one embodiment of the present invention.

In the embodiment of FIG. 3, process 200 begins in step 202 by converting a 1,4-disubstituted benzene to a Grignard reagent by reacting the 1,4-disubstituted benzene with magnesium. In the structure of 1,4-disubstituted benzene, R is one selected from the group consisting of alkyl, tert-butyl dimethyl silyl (TBS), triethyl silyl (TES), triisopropyl silyl (TIPS), tert-butyl diphenyl silyl (TBDPS), tetrahydropyran (THP), benzyl and methoxy methyl (MOM). X is one selected from the group consisting of chloride, iodide and bromide. Preferably, however, X is bromide. The solvent for the reaction in step 202 is one selected from the group consisting of diethylether, dioxane and tetrahydrofuran (THF). The solvent, however, is preferably THF. The reaction temperature may vary between about −25° C. and about 70° C., but more preferably varies between about −25 and about 25° C. The duration of the reaction may vary between about 1 and about 48 hours but more preferably varies between about 2 and about 20 hours.

Next in step 204, the Grignard reagent prepared in step 202 is reacted with a α,ω-dihaloalkane. The α,ω-dihaloalkane compound used as a reactant in step 204 is one selected from the group consisting of α,ω-dichloroalkane, α,ω-dibromoalkane or α,ω-diiodoalkane, but is preferably α,ω-dibromoalkane. Furthermore, the hydrocarbon chain in the α,ω-dihaloalkane may range from 3 to 15 carbons in length. In one embodiment of the present invention, the ratio between the Grignard reagent and the halide compound used in step 204 varies between about 1:1 and about 4:1 molar equivalents, but is preferably between about 1:1 and about 3:1 molar equivalents. The reaction time may vary between about 2 and about 120 hours, but is more preferably between about 20 and about 75 hours.

The reaction temperature may vary between about −100° C. and about 100° C., but preferably ranges between about −78° C. and about 30° C. In certain embodiments of the present invention, a catalyst used to facilitate the reaction in step 204. In such embodiments, the catalyst includes one selected from the group consisting of lithium tetrachlorocuprate, copper chloride, copper bromide, nickel chloride, and palladium. The catalyst is preferably, however, lithium tetrachlorocuprate. The ratio of the catalyst to α,ω-dihaloalkane may vary between about 0.0001:1 and about 0.03:1 molar equivalents but it preferably varies between about 0.002:1 and about 0.02:1. The catalyst may be added at once or sequentially in smaller amounts. In one embodiment of the present invention, after adequate reaction time has elapsed, the reaction is stopped. This is accomplished by adding a solution, which is one selected from the group consisting of saturated sodium chloride and saturated aqueous ammonium chloride.

In an alternative embodiment, the reaction in step 204 is stopped by adding saturated ammonium chloride. Next, in an optional step, the product of step 204 is extracted using a solvent or mixture of solvents. Such a solvent is one selected from the group consisting of diethylether, methylene chloride, chloroform, carbon tetrachloride, and ethylacetate. Also optionally, the product can then be purified by crystallization from alcohol, which includes one selected from the group consisting of methanol, ethanol, and isopropanol.

In step 206, the α,ω-bis(4-hydroxyphenyl)alkane monomer is obtained by deprotecting the phenoxy group (i.e., replacing the R groups with hydrogen attached to the phenoxy group) of the resulting product isolated in Step 204. The reagent used for deprotecting the phenoxy groups in the product of step 204 includes one member selected from the group consisting of aluminum chloride, boron tribromide, boron trichloride, trimethylsilyliodide (TMSI), tetrabutyl ammonium fluoride (TBAF), palladium on carbon, p-toluenesulfonic acid (PTSA) and hydrochloric acid. Preferably, boron tribromide is used for deprotection. The solvents used for step 206 include one selected from the group consisting of chloroform, carbon tetrachloride, THF, ethanol, methanol, ethyl acetate, methylene chloride and acetonitrile. Preferably, however, methylene chloride is used in this step. Reaction times for step 206 vary from about 1 hour to about 48 hours, but more preferably varies from about 2 hours to about 24 hours. Reaction temperatures for this step vary from about −150° C. to about 100° C. However, if boron tribromide is used for deprotection, the reaction in this step is preferably carried out at a temperature between about −100° C. and about 30° C.

After the reaction of step 206 concludes, the product obtained from this step may be purified in an optional step through crystallization, distillation, sublimation, chromatography or other techniques known in the art. If the product is purified through crystallization, then a solvent is typically used during the purification process. The solvent includes one selected from the group consisting of hexane, diethylether, chloroform, ethyl acetate, methylene chloride, ethanol, and methanol. Alternatively, the α,ω-bis(4-hydroxyphenyl)alkane monomer obtained from step 206 may be used to directly without purification.

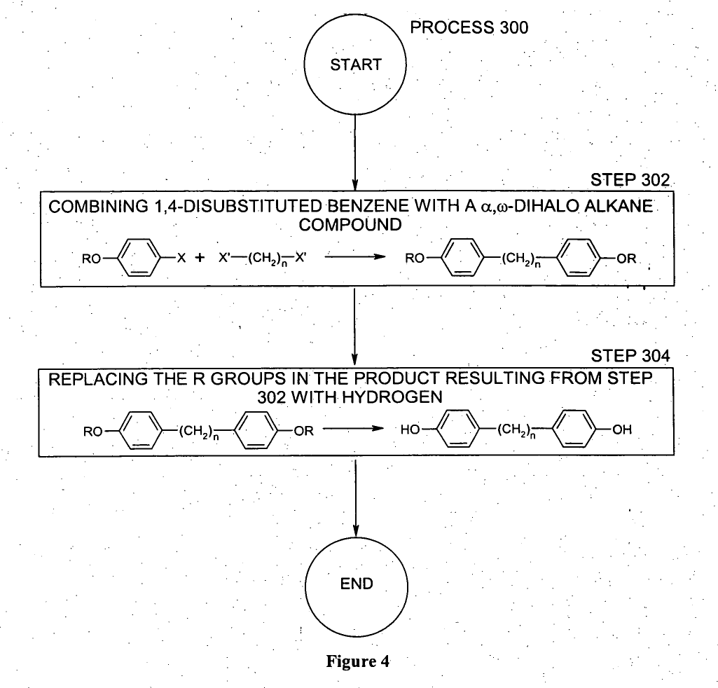

FIG. 4 is another flowchart of the significant steps involved in a process 300 of synthesizing α,ω-bis(4-hydroxyphenyl)alkane, according to an alternative embodiment of the present invention. In this embodiment, process 300 begins at step 302 by combining 1,4-disubstituted benzene with a α,ω-dihaloalkane compound in the presence of an organic solvent. The α,ω-dihaloalkane is one selected from the group consisting of α,ω-dibromoalkane type and α,ω-diiodoalkane type. Preferably, however, it is α,ω-diiodoalkane type. R includes one selected from the group consisting of alkyl, tert-butyl dimethylsilyl (TBS), triethyl silyl (TES), triisopropylsilyl (TIPS), tert-butyl diphenylsilyl (TBDPS), tetrahydropyran (THP), benzyl, and methoxymethyl (MOM). X independently includes a functional group selected from the group consisting of chloride, iodide, or bromide. X preferably is iodide. Furthermore, the hydrocarbon chain in the α,ω-dihaloalkane may range from 3 to 15 carbons in length. The organic solvent used in step 302 includes one selected from the group consisting of N,N-dimethyl acetamide (DMAc), N-methyl-2-pyrrolidinone (NMP), dimethyl sulfoxide (DMSO), and N,N-dimethyl formamide (DMF). The organic solvent in this step is preferably, however, DMSO.

In some embodiments, a catalyst is added to the reaction mixture of step 302. The catalyst includes at least one selected from the group consisting of palladium, zinc, nickel, and copper. The catalyst is preferably, however, copper. The ratio of 1,4-disubstituted benzene to α,ω-dihaloalkane in step 302 may vary between about 0.25:1 and about 4:1 molar equivalents, but is most preferably between about 0.5:1 molar equivalents and about 3:1 molar equivalents. The amount of catalyst with respect to 1,4-disubstituted benzene may vary between about 1:1 molar equivalents and about 15:1 molar equivalents but more preferably is between about 3:1 molar equivalents and about 7:1 molar equivalents. Reaction temperature of step 302 may vary between about 0° C. and about 200° C., but more preferably varies between about 70° C. and about 170° C. Duration of the reaction may vary between about 1 and about 48 hours, but more preferably varies between about 13 hours and about 25 hours. The resulting product of step 302 in an optional step can be separated by several purification techniques known to those skilled in the art such as extraction, distillation, and crystallization. Purification occurs, preferably, via crystallization from solvent which includes at least one selected from the group consisting of hexane, diethylether, chloroform, ethyl acetate, methylene chloride, ethanol and methanol.

Next in step 304, α,ω-bis(4-hydroxyphenyl)alkane monomer is obtained by deprotecting the phenoxy group of the resulting product isolated in step 302. The reagent used for deprotection includes one selected from the group consisting of aluminum chloride, boron tribromide, boron trichloride, trimethylsilyl iodide (TMSI), tetrabutylammonium fluoride (TBAF), palladium on carbon, p-toluenesulfonic acid (pTSA), and hydrochloric acid. Preferably, however, boron tribromide is used for deprotection in step 304. A solvent may be used in step 304. The solvent includes at least one selected from the group consisting of chloroform, carbon tetrachloride, THF, ethanol, methanol, ethyl acetate, methylene chloride and acetonitrile. However, it is preferable to use methylene chloride. Reaction times for step 304 varies from about 1 hour to about 48 hours, but more preferably varies between about 2 hours and about 24 hours. Reaction temperatures for this step vary from about −150° C. to about 100° C. However, if boron tribromide is used for deprotecting, the reaction in this step is preferably carried out at a temperature between about −100° C. and about 30° C.

The product obtained in step 304, in accordance with one embodiment of the present invention, is further purified through crystallization, distillation, chromatography or other techniques known in the art. Preferably, however, the α,ω-bis(4-hydroxyphenyl)alkane monomer is purified by sublimation or crystallization from an organic solvent. Such organic solvent includes one selected from the group consisting of hexane, methylene chloride, toluene, ethanol, methanol, and chloroform. It is preferable, however, to use chloroform.

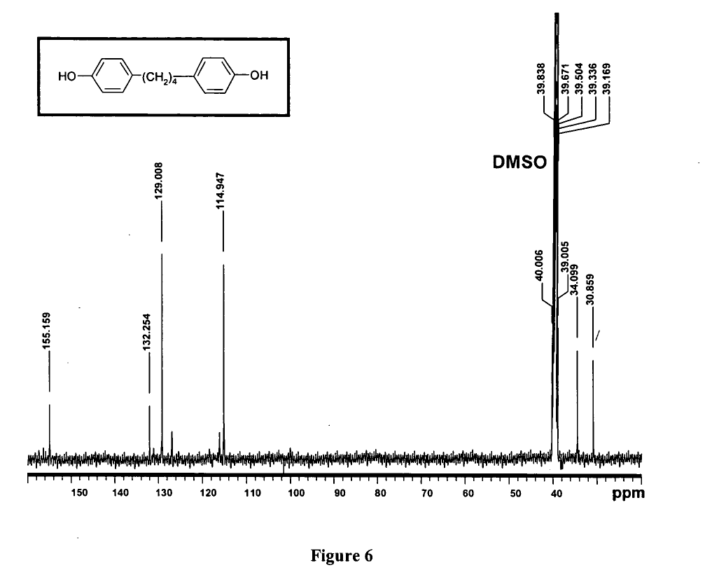

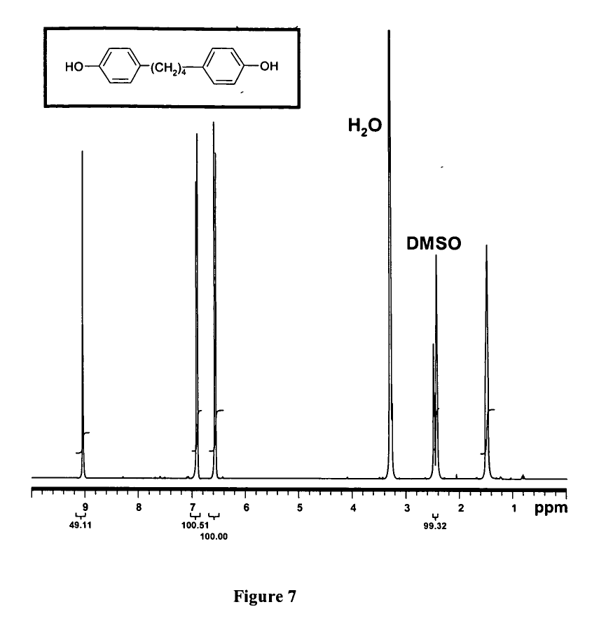

Synthesis of 1,4-bis(4-hydroxyphenyl)butane, a particular species of α,ω-bis(4-hydroxyphenyl)alkane where n is equal to 4, was confirmed by ¹³C NMR and ¹H-NMR as shown in FIGS. 6 and 7. ¹H-NMR of FIG. 7 shows five distinct peaks due to the structural symmetry of the monomer. There are two triplet and two doublet peaks which correspond to the aliphatic and aromatic protons respectively. A singlet peak corresponds to the phenolic protons. ¹³C NMR of FIG. 6 shows six peaks, which also correlate to the symmetrical nature of the novel monomer. The six peaks have field location such that they are readily coordinated with the atomic structure of the novel monomer.

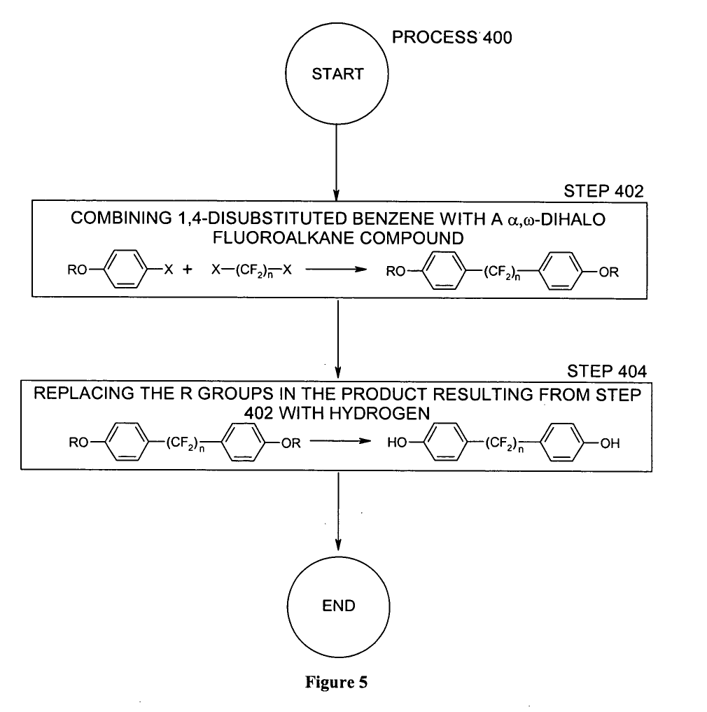

FIG. 5 is a flowchart of the significant steps involved in a process 400 of synthesizing α,ω-bis(4-hydroxyphenyl)perfluoroalkane according to an alternative embodiment of the present invention. In this embodiment, process 400 begins at step 402 by combining 1,4-disubstituted benzene with a α,ω-dihaloperfluoroalkane compound in the presence of solvent. The α,ω-dihaloperfluoroalkane is one selected from the group consisting of α,ω-dibromoperfluoroalkane type and α,ω-diiodoperfluoroalkane type. Preferably, however, it is α,ω-diiodoperfluoroalkane type. R is one selected from the group consisting of alkyl, tert-butyldimethylsilyl (TBS), triethylsilyl (TES), triisopropyl silyl (TIPS), tert-butyldiphenylsilyl (TBDPS), tetrahydropyran (THP), benzyl, and methoxymethyl (MOM). X independently includes a functional group selected from the group consisting of chloride, iodide, or bromide. X preferably is iodide.

The fluoroalkane chain in the α,ω-dihaloperfluoroalkane type may range from 1 to 15 carbons in length. The ratio of 1,4-disubstituted benzene to α,ω-dihaloperfluoroalkane in the reaction mixture varies between about 0.25:1 molar equivalents and about 4:1 molar equivalents, but is most preferably between about 0.5:1 molar equivalents and about 3:1 molar equivalents. The organic solvent used in step 402 includes one selected from the group consisting of N,N-dimethyl acetamide (DMAc), N-methyl-2-pyrrolidinone (NMP), dimethyl sulfoxide (DMSO), and N,N-dimethyl formamide (DMF). It is, however, preferable to use DMSO.

In one embodiment of step 402, a catalyst is also added to the reaction mixture which includes one selected from the group consisting of zinc, palladium, nickel, and copper. Preferably, however, copper is used. The amount of catalyst used with respect to 1,4-disubstituted benzene varies between about 1:1 molar equivalents and about 15:1 molar equivalents, but preferably varies between about 3:1 molar equivalents and about 7:1 molar equivalents.

Reaction temperature in step 402 may vary between about 0° C. and about 200° C., but preferably varies between about 70° C. and about 170° C. Duration of the reaction in step 402 may vary between about 1 and about 48 hours, but is preferably between about 13 hours and about 25 hours. The product resulting from step 402 may be separated by several purification techniques known to the art such as extraction, distillation, and crystallization. Most preferably purification is performed via crystallization from solvent which may include, but is not limited to hexane, diethylether, chloroform, methylene chloride, ethyl acetate, ethanol, and methanol.

Next, in step 404, α,ω-bis(4-hydroxyphenyl)perfluoroalkane monomer is obtained by deprotecting the phenoxy groups of the resulting product isolated in step 402. The reagent used for deprotecting the product obtained in step 402 includes one selected from the group consisting of aluminum chloride, boron tribromide, boron trichloride, and trimethylsilyliodide (TMSI), tetrabutylammonium fluoride (TBAF), palladium on carbon, p-toluenesulfonic acid (pTSA), and hydrochloric acid. Preferably, however, boron tribromide is used for deprotection in step 404.

The solvents used for step 404 include one selected from the group consisting of methylene chloride, chloroform, carbon tetrachloride, THF, ethanol, methanol, ethyl acetate, and acetonitrile. Preferably, however, methylene chloride is used. Reaction times for step 404 varies from about 1 hour to about 48 hours, but more preferably varies between about 2 hours and about 24 hours. Reaction temperatures for this step vary from about −150° C. to about 100° C. However, if boron tribromide is used for deprotecting, the reaction in this step is preferably carried out at a temperature between about −100° C. and about 30° C.

The product obtained from step 404 in an optional step can be purified through crystallization, distillation, sublimation, chromatography or other techniques known in the art. Preferably, the product is purified by sublimation or crystallization from an organic solvent. Such an organic solvent includes one selected from the group consisting of hexane, methylene chloride, toluene, ethanol, methanol, and chloroform. It is preferable, however, to use chloroform in the crystallization process.

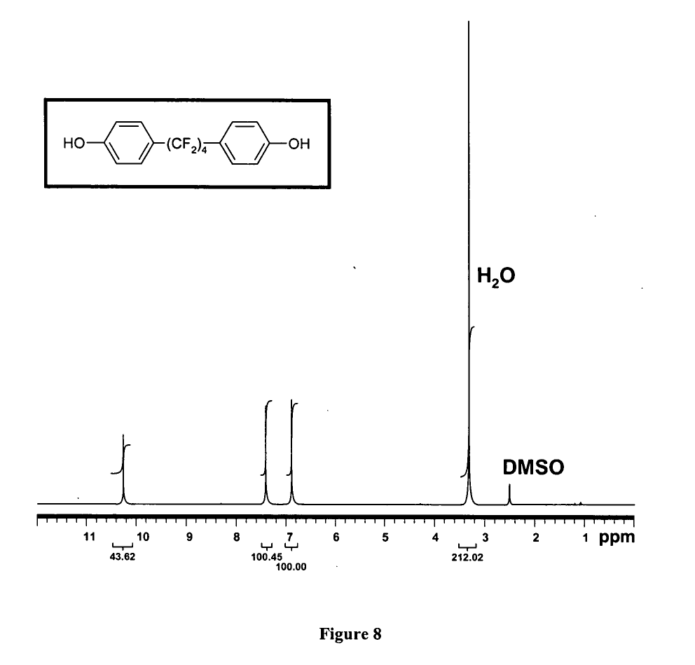

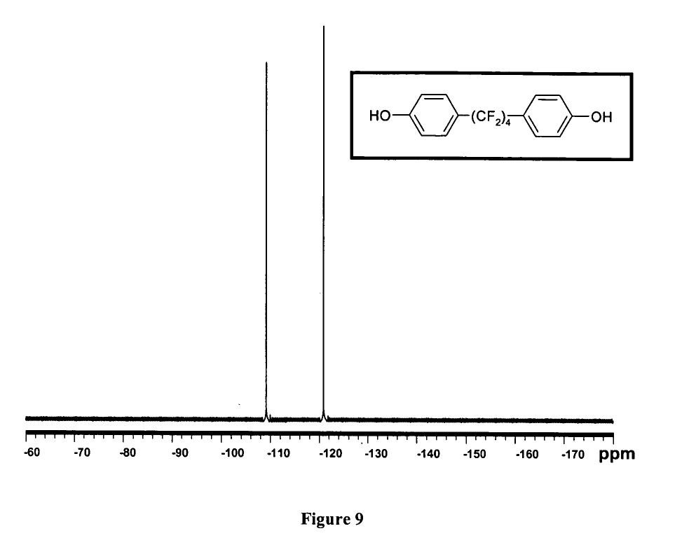

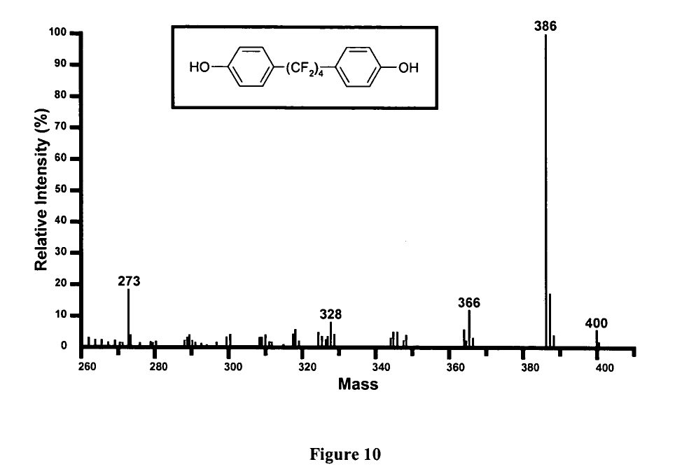

Synthesis of 1,4-bis(4-hydroxyphenyl)octafluorobutane, a particular species of α,ω-bis(4-hydroxyphenyl)perfluoroalkane where n is equal to 4, was confirmed by ¹H-NMR, ¹⁹F NMR and MS as shown in FIGS. 8, 9, and 10, respectively. ¹H-NMR and ¹⁹F NMR correlate to the structure of 1,4-bis(4-hydroxyphenyl)octafluorobutane. The ¹H-NMR in FIG. 8 shows two clear doublets and one singlet. The doublets correlate with the protons on the aromatic rings and the singlet corresponds to terminal phenolic groups. Due to the symmetric structure, the novel monomer shows only three proton NMR peaks. The peaks on the ¹⁹F NMR of FIG. 9 correlate to the fluorine atoms in the symmetrical novel monomer. The molecular mass spectrum in FIG. 10 of the novel monomer shows a clear peak at 386 daltons which is the expected mass of the inventive monomer.

Described below are the significant steps involved in a process of synthesizing α,ω-bis(4-halophenyl)perfluoroalkane, according to one embodiment of the present invention. In this embodiment, the synthesis begins by combining 1,4-dihalobenzene and α,ω-dihaloperfluoroalkane in the presence of an organic solvent as shown below, 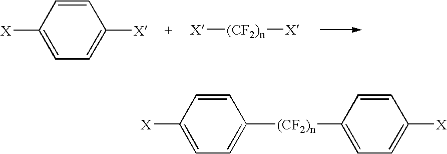
In this embodiment, X and X′ independently include one selected from the group consisting of the fluoride, chloride, bromide and iodide. Preferably, X is chloride or fluoride and X′ is bromide or iodide. The organic solvent includes one selected from the group consisting of DMAc, NMP, DMSO, and DMF. It is, however, preferable to use DMSO. In certain embodiments of the present invention, a catalyst is also added to the reaction mixture which includes one member selected from the group consisting of palladium, zinc, iron, nickel, and copper. It is, however, preferable to use copper. The amount of catalyst used with respect to 1,4-dihalobenzene may vary between about 1:1 molar equivalents and about 15:1 molar equivalents, but is preferably between about 3:1 molar equivalents and about 7:1 molar equivalents.

The ratio of 1,4-dihalobenzene to α,ω-dihaloperfluoroalkane in the reaction mixture may vary between about 0.25:1 molar equivalents and about 4:1 molar equivalents, but is preferably between about 1:1 molar equivalents and about 3:1 molar equivalents. Reaction temperature in this step may vary between about 0° C. and about 200° C., but preferably varies between about 70° C. and about 170° C. Duration of the reaction of 1,4-dihalobenzene and α,ω-dihaloperfluoroalkane in this step may vary between about 1 hour and about 48 hours, but preferably varies between about 13 hours and about 25 hours.

The products obtained from this reaction of 1,4-dihalobenzene and α,ω-dihaloperfluoroalkane may be separated by several techniques known to the art such as extraction, distillation, sublimation and crystallization. Preferably, however, the α,ω-bis(4-halophenyl)perfluoroalkane monomer is purified by sublimation or by crystallization in organic solvents, which includes one selected from the group consisting of hexane, methylene chloride, toluene, ethanol, methanol, and chloroform. It is, however, preferable to use chloroform.

The α,ω-bis(4-halophenyl)perfluoroalkane monomer can also be prepared by using other synthesis techniques. In an alternative embodiment of the present invention, this monomer may be prepared by combining 1,4-dihalobenzene and a Grignard reagent prepared from a α,ω-dihaloperfluoroalkane in the presence of an organic solvent, as shown below 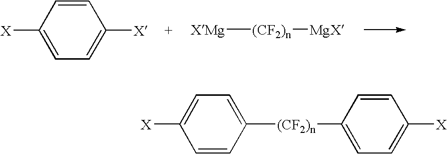
In this alternative embodiment, X and X′ includes the halogen type. Preferably however, X′ is bromide or iodide and X is fluoride. The integer “n” may range in value from 1 to 15. In one embodiment of the present invention, the solvent for the reaction is one selected from the group consisting of diethylether, dioxane and tetrahydrofuran (THF), but is preferably THF. After adequate reaction time, the reaction may be stopped by adding a solution, which is one selected from the group consisting of water, saturated sodium chloride, and saturated aqueous ammonium chloride. Next, the desired product may be extracted using an organic solvent or mixture of solvents. Such a solvent includes one selected from the group consisting of diethylether, methylene chloride, chloroform, carbon tetrachloride, and ethyl acetate. Optionally, the product can then be purified by crystallization from alcohol, which is one selected from the group consisting of hexane, methanol, ethanol, and isopropanol.

The present invention also provides novel polymers which incorporate at least one inventive repeat unit. The repeat unit is derived from the above-described inventive monomers, preferred embodiments of which are set forth in Table 1. Those skilled in the art will recognize that the final structure of the repeat units will depend on the synthesis pathways undertaken to make the polymer or polymers. In one embodiment, repeat units used in the polymer of the present invention have a general structure: 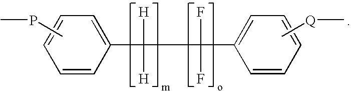
In this embodiment, P and Q independently may be functional groups selected from the group consisting of ethers, sulfides, sulfones, ketones, esters, amides, imides and carbon-carbon bonds. Furthermore, P and Q independently may attach at any one of the ortho, meta or para positions to the aromatic ring. In alternative embodiments, the above-identified polymer structure of the present invention includes independent functional groups G and G′ which are not shown in the diagram. G and G′ independently are one member selected from a group consisting of hydrogen, sulfonic acids, phosphoric acids, carboxylic acids, sulfonamides and imidazoles. Furthermore, G and G′ may be fluorinated or nonfluorinated aliphatic chains containing one or more of the aforementioned group compounds. G and G′ may be situated on any one of the ortho, meta, or para positions to P or Q independently.

Integer value “m” is between 0 and 15 and represents the number of methylene units. Integer value “o” is between 1 and 15 and represents the number of fluorinated methylene units. Typical values for the sum of “m” and “o” range from 1 to 15. Furthermore, the order of the methylene and fluorinated methylene groups in the novel monomer may be random or specific in nature. The methylene and fluorinated methylene aliphatic units are referred to as the aliphatic spacer. The novel monomer repeat units may appear in the inventive polymer in statistically random fashion or as a block in the polymer chain.

In alternative embodiments of the polymer according to the present invention, the aliphatic spacer between the phenyl rings may contain at least one methylene unit, without including any fluorinated methylene units. In this embodiment of the inventive polymer, integer “m” includes 3, 4, 5, 7, 8, 9, 10, 11, 12, 13, 14, and 15 and represents the number of methylene units in the aliphatic spacer unit. This polymer structure is consistent with the alternative embodiment of the inventive monomer structure described above.

Polymers with repeat units derived from the inventive monomers offer significant advantages over the polymers found in the prior art. Specifically, the polymer of the present invention possess desirable properties when used as proton exchange membrane in fuel cells because they are inexpensive, exhibit low methanol crossover, and exhibit improved electrode-electrolyte adhesion than most thermoplastic based membranes. As a result, the present invention offers a method of making a proton exchange material using the inventive polymer, which provides the advantages realized by thermoplastic based membranes without suffering from the disadvantages encountered by such membranes in the prior art. The amount of the inventive monomer used in the polymer may vary depending on the functional characteristics needed for the specified applications, but preferred embodiments incorporate between about 0.1 to about 100%.

Structures of the different embodiments of the inventive polymer are shown below in Table 2.

TABLE 2

| Polymer | Structure |
|---|---|
| Polymer 1 | 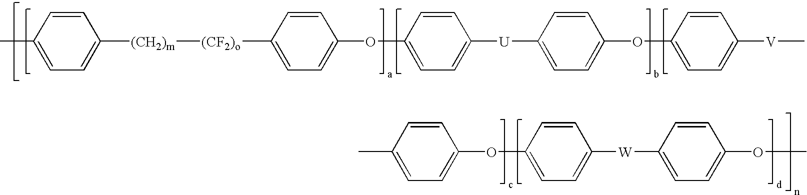 |
| Polymer 2 | 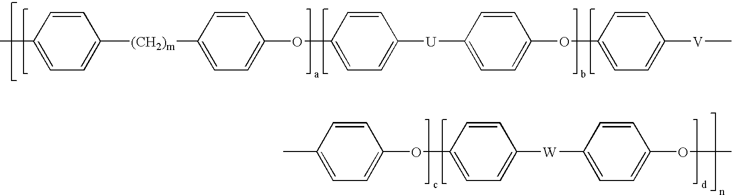 |
| Polymer 3 | 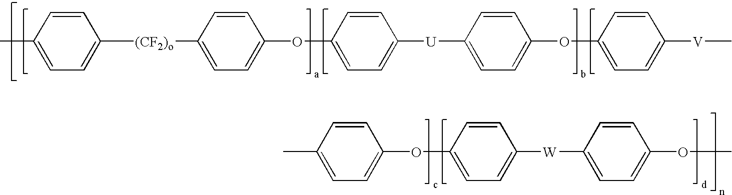 |

In the inventive polymer embodiments described above in Table 2, repeat unit “a” varies from about 0.1% to about 100% molar percent and the number of repeat units “b,” “c,” and “d” may all vary from about 0 to about 50%. U, V and W are functional groups selected from the group consisting of sulfones, ketones, carbon-carbon bonds, branched carbon based structures, alkenes, alkynes, amides, and imides. In alternative embodiments, the above-identified polymers in Table 2 includes G and G′ on some or all the aromatic rings which are not shown in this table. G and G′ independently are one selected from the group consisting of sulfonic acids, phosphoric acids, carboxylic acids, sulfonamides and imidazoles, and may be situated on the ortho or meta, positions to the either, U, V, or W. Furthermore, G and G′ may be fluorinated or nonfluorinated aliphatic chains containing one or more of the aforementioned group compounds. Integer values “m” and “o” are between 0 and 15. Integer “m” ranges between 0 and 15 and integer “o” ranges between 1 and 15. When integer “o” equals zero, integer “m” can equal one of 3, 4, 5, 7, 8, 9, 10, 11, 12, 13, 14, and 15.

There are particular examples of the above-identified polymers that are noteworthy as proton exchange membrane materials. For example, polymer with the following structure is a particular case of Polymer 2 of Table 2. 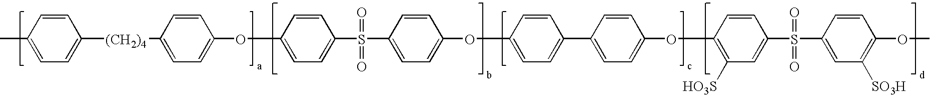
As another example, polymer with the following structure is a particular case of Polymer 3 of Table 2.

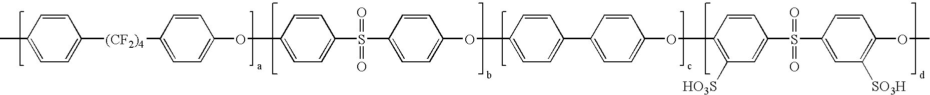

A reaction, according to one embodiment of the present invention, for producing an inventive polymer is shown in FIG. 11.

The number of repeat units “a,” “b,” “c,” and “d” depicted in this reaction scheme vary depending on the properties of polymer needed. Molar values of “a” may range from about 0.1% to about 100%. Molar values of “b,” “c,” and “d” may all vary from about 0% to about 50%. U, V, and W independently include a functional group selected from the group consisting of sulfones, ketones, and carbon-carbon bonds, branched structures carbon based structures, alkenes, amides, and imides. G and G′ are optional functional groups which facilitate proton conductivity (or performance) in hydrogen fuel cell membranes. In one embodiment of the present invention, G and G′ independently are one member selected from the group consisting of hydrogen, sulfonic acids, phosphoric acids, carboxylic acids, sulfonamides and imidazoles. Furthermore, G and G′ may be fluorinated or nonfluorinated aliphatic chains containing one or more of the aforementioned group compounds. Y, Y′, Y″, and Y′″ independently are one selected from the group consisting of fluorine, chlorine, bromine, iodine, hydroxyl, carboxylic acid, trimethylsiloxy, nitro and amines. Preferred embodiments of the present invention include an equal molar ratio of halogen and nitro group to hydroxyl groups among the monomers. Additionally, the ratio of monomers a:b:c:d determines the overall composition and properties of the polymer. Integer “m” ranges between 0 and 15 and integer “o” ranges between 1 and 15. When integer “o” equals zero, integer “m” can equal one of 3, 4, 5, 7, 8, 9, 10, 11, 12, 13, 14, and 15. Typical values for the sum of “m” and “o” range from 1 to 15. Those skilled in the art will recognize that numerous embodiments of the inventive polymer contains at a minimum only the first inventive monomer reactant shown in FIG. 11 and need not contain any of the other monomer reactants, which include the functional groups represented by U, V and W. In other words, the polymer structure of the present invention may contain at a minimum one inventive monomer composition.

In a starting step of the embodiment shown in FIG. 11, the monomer components are combined in precise stoichiometric amounts under a substantially dry and inert atmosphere. The components are generally dispersed in a solvent. Such a solvent is one selected from the group consisting of N,N-dimethylformamide (DMF), N,N-dimethyl acetamide (DMAc), N-methyl-2-pyrrolidinone (NMP), dimethyl sulfoxide (DMSO), and diphenyl sulfoxide (DPSO). It is, however, preferable to use NMP and DMSO. Additionally, an azeotropic component may be added to facilitate the removal of water formed as a byproduct from the solution. A typical azeotropic component includes one selected from the group consisting of toluene, benzene and xylene. It is, however, preferable to use toluene and benzene.

To facilitate the monomer combination reaction, an inorganic base is added in certain embodiments of the present invention. In such embodiments, the inorganic base is one selected from the group consisting of potassium carbonate, cesium carbonate, sodium carbonate, sodium hydroxide, potassium hydroxide and sodium hydride. It is, however, preferable to use potassium carbonate. The molar ratio of the inorganic base varies between about 0.75:1 and about 2.5:1, but is preferably between about 1:1 and about 1.5:1. The monomer combination reaction temperatures vary a wide range, but typically range from about 100° C. to about 350° C., but are preferably between about 130° C. and about 220° C. Reasonable monomer combination reaction time ranges from about 2 hours to about 72 hours, but preferably is between about 5 and about 24 hours. After the reaction concludes and cools off, the resulting reaction mixture is poured into water, solvent, or a mixture of water and solvent to precipitate the polymer. Solvents are one selected from the group consisting of ethanol, methanol, isopropyl alcohol, diethylether, and chloroform. The polymer may then be purified by known techniques and dried.

Another synthesis method of the inventive polymer is shown in FIG. 12A. This method is similar to the method described above. However, the resulting product of this method is a more specific example of the product produced in the earlier described method of FIG. 11. In this embodiment of the present invention, the number of monomer units “a,” “b,” “c,” and “d” varies depending on the properties of polymer needed. The values of monomer unit “a” may range from about 0.1% to about 100%. Molar values of “b,” “c,” and “d” may all vary from about 0% to about 50%. n ranges from 1 to 15. U, V, and W independently include a functional group selected from the group consisting of sulfones, ketones, and carbon-carbon bonds, branched structures carbon based structures, alkenes, amides, and imides. Y, Y′, Y″, and Y′″ are one selected from the group consisting of fluorine, chlorine, bromine, nitro and hydroxyl group. Preferably, inventive monomer molar ratios are between about 0.1% and about 50% for monomer “a,” about 0% and about 50% for monomer “b,” about 0% and about 50% for monomer “c,” and about 0% and about 50% for monomer “d.” Preferably, Y, Y′ and Y″ are chloro or fluoro groups and X is a hydroxyl group. To obtain polymers with higher molecular weights, it is preferred to keep the value of a+b+d equal to c. Additionally, the ratio of monomers a:b:c:d determines the overall composition and properties of the polymer.

In a starting step of the embodiment shown in FIG. 12A, the starting monomer components are combined in precise stoichiometric amounts under a dry, inert atmosphere. The components are generally dispersed in a solvent. The solvent include at least one selected from the group consisting of N,N-dimethylformamide (DMF), N,N-dimethyl acetamide (DMAc), N-methyl-2-pyrrolidinone (NMP), dimethyl sulfoxide (DMSO), and diphenyl sulfoxide (DPSO), but preferably includes NMP and DMSO. Additionally, an azeotropic component may be added to facilitate the removal of water formed as a byproduct from the solution. The azeotropic component includes one selected from the group consisting of toluene, benzene and xylene, but preferably includes toluene and benzene.

To facilitate the reaction an inorganic base is added in certain embodiments of the present invention. In such embodiments, the inorganic base includes, but is not limited to, potassium carbonate, sodium carbonate, cesium carbonate, sodium hydroxide, potassium hydroxide, sodium hydride. It is, however, preferable to use potassium carbonate. The molar ratio of the inorganic base varies between about 0.75:1 and about 2.5:1 but is preferably between about 1:1 and about 1.5:1. Reaction temperatures vary but typically range from about 100 to about 350° C., but are more preferably between about 130 and about 220° C. Reasonable reaction times range from about 2 to about 72 hours, but more preferably occurs between about 4 and about 24 hours. Afterwards, the reaction is allowed to cool and the resulting reaction mixture is poured into water, solvent, or a mixture of water and solvent to precipitate the polymer. Solvents include, but are not limited to ethanol, methanol, and isopropyl alcohol. The polymer is then purified by known techniques and protonated and dried before use. The reaction description is only meant to give the reader a general overview of how the reaction can proceed. Those skilled in the art will recognize other mechanisms and reaction parameters may be used to generate the desired polymers that incorporate the inventive monomers or repeat units.

In an alternative embodiment of the present invention, the inventive polymer may be prepared by reacting the hydroxy functionalized monomer with dicarboxylic acid or dicarboxylic acid halide as shown in the reaction in FIG. 12B.

In FIG. 12B, R is any aliphatic or aromatic compound that includes one selected from the group consisting of dicarboxylic acid, dicarboxylic acid chloride, or dicarboxylic acid fluoride.

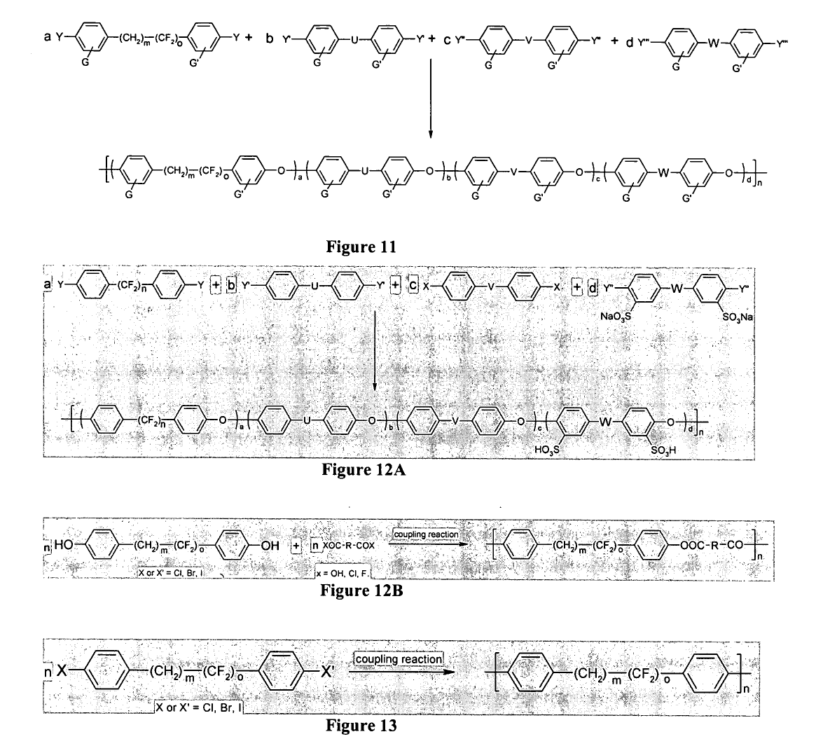

In another alternative embodiment of the present invention, the inventive monomers is incorporated into the polymer structure is by self coupling the halogen functionalized inventive monomer as depicted in FIG. 13.

Once the inventive polymer is synthesized, it can be further made into a thin film, which in turn is used in numerous applications, some of which are described below. The inventive polymers may be processed into a thin film by solvent casting, tape casting, or any form of melt casting including but not limited to extrusion, calendaring, and injection molding. The resulting film allows for a greater range of processing methods. The film formed from post polymerization processing is a transparent ductile product, which can be protonated in an acidic solution to form a proton conducting electrolyte. The proton conducting electrolyte can be further processed to form a MEA.

The MEA is most typically comprised of a solid polymer electrolyte membrane which is sandwiched between a pair of electrodes. Most conventionally, the polymeric membrane may be hot pressed between two catalyst coated electrodes to form the MEA structure. Furthermore, such methods as sputtering, spraying, painting, and others may be used to adhere the catalyst layer to the membrane.

The resulting MEA may be incorporated into proton exchange membrane fuel cells which are described, for example, in U.S. Pat. Nos. 5,248,566 and 5,547,777. In addition, several fuel cells can be connected in series by conventional means to fabricate or assemble fuel cell stacks. The resulting fuel cell can be used as a power source to power any conventional electronic device or load.

The inventive monomer, inventive polymer electrolyte, and the inventive MEA show superior performance relative to its prior art counterparts. To highlight the benefits of the invention and its significance, several iterations of the inventive polymer were compared to a comparative prior art example, which was an acid functionalized thermoplastic and did not contain the inventive monomer or repeat unit. The general structure of the comparative prior art example is provided below, where “b,” “c” and “d” are equal to 20%, 50% and 30%, respectively.

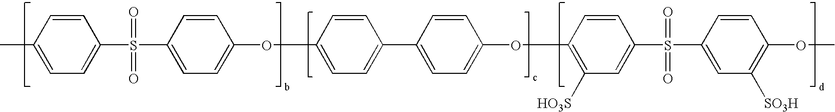

Table 3 highlights various embodiments of the Polymer 2 type shown in Table 2 along with the comparative prior art example. The monomer ratios in the inventive polymers and the comparative prior art example are also provided in Table 3.

TABLE 3

Monomer Molar Percentage (%)

| Iteration | a | b | c | d |
|---|---|---|---|---|
| Comparative | 0 | 20 | 50 | 30 |
| Example | | | | |
| Inventive Polymer 1 | 12.5 | 20 | 37.5 | 30 |
| Inventive Polymer 2 | 25.0 | 20 | 25.0 | 30 |
| Inventive Polymer 3 | 37.5 | 20 | 12.5 | 30 |
| Inventive Polymer 4 | 50.0 | 20 | 0 | 30 |

As can be seen from Table 4, varying the amount of inventive monomer repeat units imparts significant characteristic changes between the inventive polymer iterations and comparative example.

TABLE 4

| | Material Properties | | | |
|---|---|---|---|---|
| | | | | MEA |
| | Conductivity | | | adhesion |
| Iteration | (S/cm @ 80 C.) | IEC | Tg (° C.) | percentage |
| Comparative Example | 0.03 | 1.04 | 265 | 5% |
| Inventive Polymer 1 | 0.055 | 1.12 | 230 | 100% |
| Inventive Polymer 2 | 0.056 | 1.107 | 214 | 100% |
| Inventive Polymer 3 | 0.062 | 1.019 | 173 | 100% |
| Inventive Polymer 4 | 0.068 | 0.964 | 168 | 100% |

The inventive polymer iterations depicted in Tables 3 and 4 highlight the influence of the inventive monomer. As can be seen from Table 4, the chemical and physical properties of the inventive polymers change significantly with the composition of the inventive monomer.

The trend in conductivity of the polymer shows that the presence of the inventive novel monomer units in the polymer improves the electrochemical properties of the resulting polymer and membrane. Such improvements in the electrochemical characteristics were not attained by prior art membranes. The increase in conductivity may be a result of a change in microstructure of the polymer due to the increasing amount the novel monomer. Those skilled in the art recognize that increased conductivity leads to increased fuel cell performance.

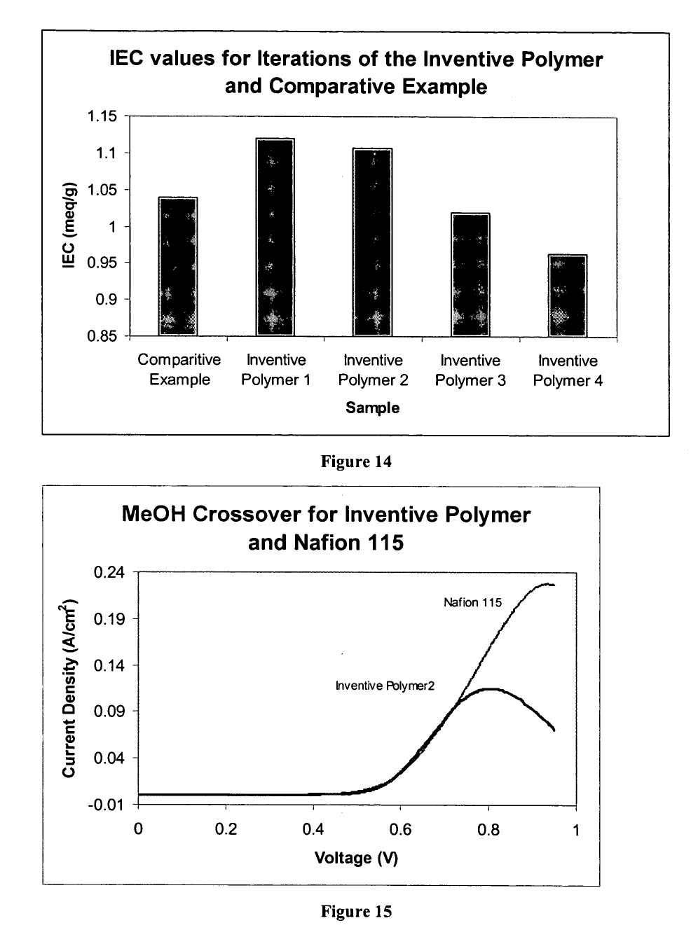

As shown in FIG. 14, the ion exchange capacities (IECs) of the inventive polymer system shows a clear decrease with the increase of the novel monomer repeat units. The decrease in IEC corresponds to the increase in molecular weight of the resulting polymer's theoretical repeat unit. The heavier novel monomer repeat unit effectively reduces the exchange capacity when normalized per gram of the polymer material.

The novel polymer system also shows a significant decrease in methanol crossover compared to Nafion® and other PFSA based membranes. The lower methanol crossover is associated with the chemical and physical structure of the polymer material. The aromatic nature of the inventive polymer may have a structure such that less methanol permeates through its MEA versus that of a PFSA MEA as demonstrated in FIG. 15. The greater methanol impermeability reduces the electrochemical losses resulting from the partial shorting of the fuel cell reaction due to methanol crossover.

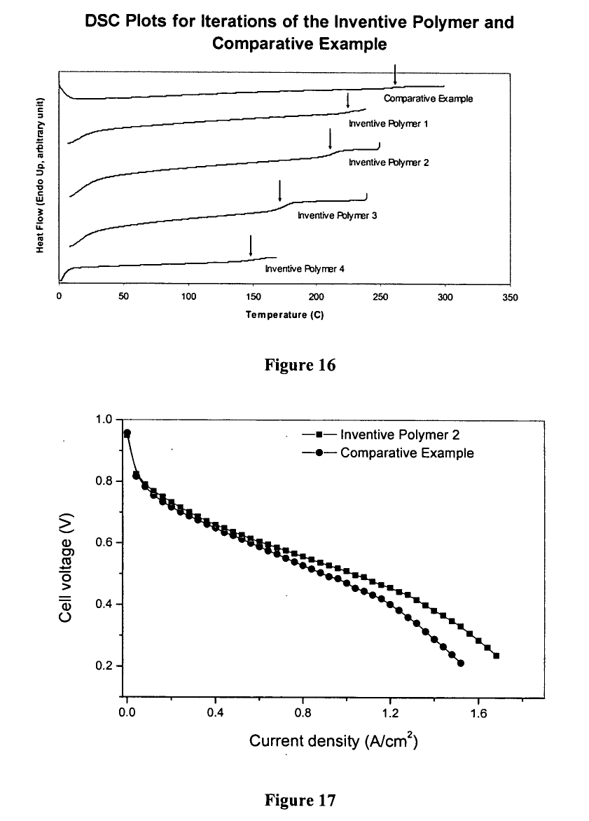

Increasing the amount of the disclosed monomer increases the flexibility of the polymer chains thereby allowing for greater polymer chain mobility. The increased polymer mobility yields film flexibility with a reduced Tg. Lower Tg contribute to improved electrode-electrolyte adhesion and easier membrane electrode assembly processing and superior performance as an ionomer for electrochemical device use. FIG. 16 highlights the Tg of the disclosed polymer change with various loadings of the inventive monomer. As the amount of the inventive monomer ratio is increased, the Tg of the resulting polymer decreases. It is believed that the reduction in Tg imparts better MEA adhesion quality.

As can be seen in Table 4, as the Tg of the inventive polymer decreases, the overall catalyst adhesion improves. This Membrane Adhesion Percentage represents the percentage of catalyst that adheres to the membrane after hydroscopic treatment (i.e., boiling in water for some period of time). Note that the comparative example polymer has only 5% adhesion under similar conditions compared to 100% for the inventive polymer. Adhesion might not only be due to softening point of the polymer but also a morphological change which imparts better compatibility between membrane and electrode.

Better MEA adhesion leads to better fuel cell performance. The fuel cell performance data in FIG. 17 illustrates the positive performance effects of the novel monomer and polymer. Note that compared to the comparative example, Inventive Polymer 2 shows a significant performance increase most notably in the high current density region of the polarization curve. These MEAs were made in similar fashion, with similar electrodes, assembly procedures and testing protocol to show the performance improvement of the inventive polymer.

Although the present invention is described in terms of fuel cell applications, those skilled in the art will recognize that the inventive structures and techniques described herein can be used for other applications. For example, the inventive monomer can be used to synthesize membranes used in separation process, such as liquid-liquid separation, pervaporation, gas-liquid separation, vapor-liquid separation.

1. A monomer composition comprising: 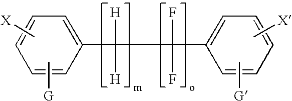
wherein X and X′ independently include a functional group selected from the group consisting of hydroxy, halogen, nitro, carboxylic acid, trimethylsiloxy and amines;
G and G′ independently include one member selected from the group consisting of hydrogen, sulfonic acid, phosphoric acid, carboxylic acid, sulfonamide, and imidazole;
m being an integer and having a value in the range from 0 to 15; and
o being an integer and having a value in the range from 1 to 15.

2. The monomer composition of claim 1 wherein a sum of said integers m and o is a value ranging from 1 to 15.

3. The monomer composition of claim 1, wherein said monomer is one member selected from the group consisting of α,ω-bis(4-hydroxyphenyl)perfluoroalkane and α,ω-bis(4-halophenyl)perfluoroalkane.

4. The monomer composition of claim 1, where in said G and said G′ are fluorinated or nonfluorinated aliphatic chains containing one member selected from the group consisting of hydrogen, sulfonic acid, phosphoric acid, carboxylic acid, sulfonamide, and imidazole.

5. The monomer composition of claim 1, wherein said X and said X′ independently may be attached at any one of the ortho, meta or para positions to their corresponding aromatic ring.

6. A monomer composition, comprising: 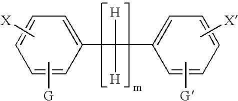
wherein X and X′ independently include a functional group selected from the group consisting of hydroxy, halogen, nitro, carboxylic acids, trimethylsiloxy, and amines;
G and G′ independently is one member selected from the group consisting of hydrogen, sulfonic acids, phosphoric acids, carboxylic acids, sulfonamides, and imidazoles; and
m being an integer and having a value that is one of 3, 4, 5, 7, 8, 9, 10, 11, 12, 13, 14, and 5.

7. The monomer of claim 6 which is α,ω-bis(4-hydroxyphenyl)alkane.

8. A process for producing a α,ω-bis(4-hydroxyphenyl)alkane monomer, comprising the steps of:
(a) converting a 1,4-disubstituted benzene to a Grignard reagent;
(b) reacting said Grignard reagent with a α,ω-dihaloalkane;
(c) deprotecting a product of said step (b) to produce said α,ω-bis(4-hydroxyphenyl)alkane monomer.

9. The process of claim 8, wherein said 1,4-disubstituted benzene has a general structure of: 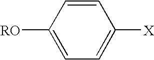
wherein R is one selected from the group consisting of alkyl, tert-butyldimethyl silyl, triethylsilyl, triisopropylsilyl, tert-butyldiphenylsilyl, tetrahydropyran, benzyl and methoxy methyl; and
X is one selected from the group consisting of chloride, iodide and bromide.

10. The process of claim 9, wherein said step (a) is carried out using a solvent, which includes one member selected from the group consisting of diethylether, dioxane and tetrahydrofuran.

11. The process of claim 8, wherein said step (a) is carried out at a temperature that is between about −25° C. and about 70° C.

12. The process of claim 11, wherein said step (a) is carried out at a temperature that is between about −25° C. and about 25° C.

13. The process of claim 8, wherein said step (a) has a duration that is between about 1 hour and about 48 hours.

14. The process of claim 8, wherein said α,ω-dihaloalkane used in said step (b) includes one member selected from the group consisting of α,ω-dichloroalkane, α,ω-dibromoalkane or α,ω-diiodoalkane.

15. The process of claim 8, wherein a length of a hydrocarbon chain in said α,ω-dihaloalkane is a number between 3 and 15 carbons in length.

16. The process of claim 8, wherein in said step (b), a ratio between said Grignard reagent and said α,ω-dihaloalkane is between about 1:1 and about 4:1 molar equivalents.

17. The process of claim 8, wherein in a reaction temperature in said step (b) is between about −78° C. and about 30° C.

18. The process of claim 8, wherein a reaction time in said step (b) is between about 2 hours and about 120 hours.

19. The process of claim 8, wherein said step (b) is conducted using a catalyst, which includes one member selected from the group consisting of lithium tetrachlorocuprate, copper chloride, copper bromide, nickel chloride, and palladium.

20. The process of claim 19, wherein the ratio of the catalyst to α,ω-dihaloalkane may vary between about 0.0001:1 molar equivalents and about 0.03:1 molar equivalents.

21. The process of claim 8, further comprising stopping reaction in said step (b) by adding a solution, which includes one member selected from the group consisting of water, saturated sodium chloride, and saturated aqueous ammonium chloride.

22. The process of claim 8, further comprising extracting said product obtained from said step (b) using an organic solvent, which includes one member selected from the group consisting of diethylether, methylene chloride, chloroform, carbon tetrachloride and ethylacetate.

23. The process of claim 8, further comprising crystallizing a product resulting from said step (b) using alcohol.

24. The process of claim 23, wherein said alcohol is one member selected from the group consisting of methanol, ethanol and isopropanol.

25. The process of claim 8, wherein said step (c) is carried out using a deprotecting reagent, which includes one member selected from the group consisting of aluminum chloride, boron tribromide, boron trichloride, trimethylsilyl iodide, tetrabutylammonium fluoride, palladium on carbon, p-toluenesulfonic acid and hydrochloric acid.

26. The process of claim 8, wherein in said step (c) is carried out using a solvent, which includes one member selected from the group consisting of chloroform, carbon tetrachloride, THF, ethanol, methanol, ethyl acetate, methylene chloride and acetonitrile.

27. The process of claim 8, wherein said step (c) has a duration that is between about 1 hour and about 48 hours.

28. The process of claim 8, wherein said step (c) is carried out at a temperature that is between about −150° C. and about 100° C.

29. The process of claim 8, further comprising purifying a product obtained from said step (c) by performing at least one of crystallization, distillation, sublimation and chromatography.

30. A process for producing a α,ω-bis(4-hydroxyphenyl)alkane monomer, comprising the steps of:
(a) combining a 1,4-disubstituted benzene with a α,ω-dihaloalkane compound; and
(b) deprotecting the phenoxy groups present in a product obtained from said step (a) by reacting said product with a reagent, which includes a member selected from the group consisting of aluminum chloride, boron tribromide, boron trichloride, trimethylsilyl iodide, tetrabutylammonium fluoride, palladium on carbon, p-toluene sulfonic acid, and hydrochloric acid.

31. The process of claim 30, wherein said 1,4-disubstituted benzene has a general structure of: 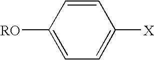
wherein R is one selected from the group consisting of alkyl, tert-butyldimethylsilyl, triethylsilyl, triisopropylsilyl, tert-butyldiphenylsilyl, tetrahydropyran, benzyl and methoxy methyl; and
X is one selected from the group consisting of chloride, iodide and bromide.

32. The process of claim 30, wherein said α,ω-dihaloalkane compound has a general structure of:
X′—(CH₂)ₙ—X′
wherein said X′ includes one member selected from the group consisting of chloride, iodide, and bromide.

33. The process of claim 30, wherein said product of said step (a) has a general structure of:

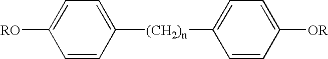

34. The process of claim 30, wherein in said step (a), a ratio between said 1,4-disubstituted benzene with a α,ω-dihaloalkane compound is between about 0.25:1 molar equivalents and about 4:1 molar equivalents.

35. The process of claim 30, wherein in a reaction temperature in said step (a) is between about 0° C. and about 200° C.

36. The process of claim 30, wherein a duration of said step (a) is between about 1 hour and about 48 hours.

37. The process of claim 30, wherein said step (a) is conducted using a catalyst, which includes one member selected from the group consisting of palladium, zinc, nickel, and copper.

38. The process of claim 37, wherein an amount of said catalyst with respect to said 1,4-disubstituted benzene is between about 1:1 molar equivalents and about 15:1 molar equivalents.

39. The process of claim 30, further comprising separating said product of said step (a) by performing at least one of extraction, distillation and crystallization.

40. The process of claim 39, wherein separating is carried out by performing crystallization using a solvent, which includes one selected from the group consisting of hexane, diethylether, chloroform, ethyl acetate, methylene chloride, ethanol, and methanol.

41. The process of claim 30, wherein said step (b) is carried out using a deprotecting reagent, which includes one member selected from the group consisting of aluminum chloride, boron tribromide, boron trichloride, trimethylsilyl iodide, tetrabutylammonium fluoride, palladium on carbon, p-toluenesulfonic acid and hydrochloric acid.

42. The process of claim 41 wherein the product of said step (b) is crystallized from an organic solvent, wherein the organic solvent is a member selected from the group consisting of hexane, methylene chloride, toluene, ethanol, methanol, and chloroform.

43. A process for producing a α,ω-bis(4-hydroxyphenyl)perfluoroalkane monomer, comprising the steps of:
(a) combining a 1,4-disubstituted benzene with a α,ω-dihaloperfluoroalkane compound
(b) deprotecting the phenolic groups present in a product resulting from step (a) using a solvent, which includes at least one member selected from the group consisting of methylene chloride, chloroform, carbon tetrachloride, THF, ethanol, methanol, ethyl acetate, and acetonitrile.

44. The process of claim 43, wherein said 1,4-disubstituted benzene has a general structure of: 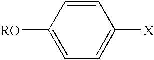
wherein R is one selected from the group consisting of alkyl, tert-butyl dimethylsilyl, triethylsilyl, triisopropylsilyl, tert-butyldiphenylsilyl, tetrahydropyran, benzyl, and methoxymethyl;
X includes one selected from the group consisting of an iodide group and a bromide group.

45. The process of claim 43, wherein said α,ω-dihaloperfluoroalkane compound has a general structure of:
X′—(CF₂)ₙ—X′
wherein said X′ includes one member selected from the group consisting of chloride, iodide, and bromide.

46. The process of claim 43, wherein said product of said step (a) has a general structure of:

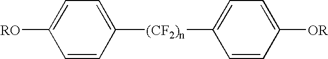

47. The process of claim 43, wherein said n ranges from 1 to 15 carbons in length.

48. A polymer composition containing at least one repeat unit, said repeat unit, comprising: 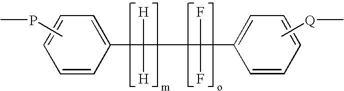
wherein P and Q independently are functional groups selected from the group consisting of ethers, sulfides, sulfones, ketones, esters, amides, imides and carbon-carbon bonds;
m is an integer representing a number of methylene units and ranging between 0 and 15; and
o is an integer representing a number of fluorinated methylene units and ranging between 1 and 15.

49. The polymer composition of claim 48, wherein said polymer has a general structure of: 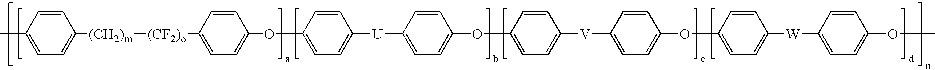
wherein a is between about 0.1% and about 100% molar percent,
b, c, and d independently are between about 0 and about 50% molar percent,
U, V and W independently are functional groups selected from the group consisting of sulfones, ketones, carbon-carbon bonds, branched carbon based structures,

50. The polymer composition of claim 48, wherein said polymer has a general structure of: 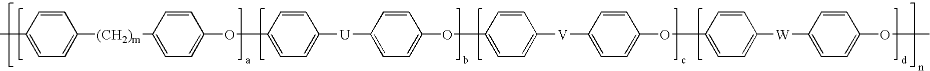
wherein a is between about 0.1% and about 100% molar percent,
b, c, and d independently are between about 0 and about 50% molar percent,
U, V and W independently are functional groups selected from the group consisting of sulfones, ketones, carbon-carbon bonds, branched carbon based structures, alkenes, alkynes, amides, and imides.

51. The polymer composition of claim 50, wherein said polymer has a structure of:

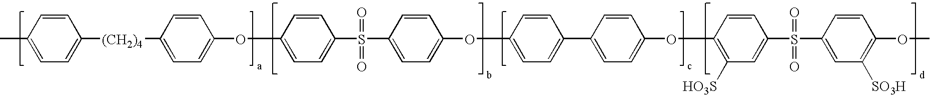

52. The polymer composition of claim 48, wherein said polymer has a general structure of: 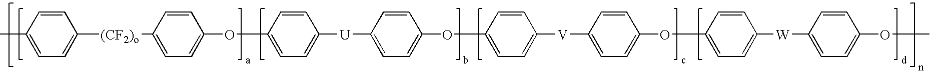
wherein a is between about 0.1% and about 100% molar percent,
b, c, and d independently are between about 0 and about 50% molar percent,
U, V and W independently are functional groups selected from the group consisting of sulfones, ketones, carbon-carbon bonds, branched carbon based structures, alkenes, alkynes, amides, and imides.

53. The polymer composition of claim 48, wherein said polymer has a general structure of

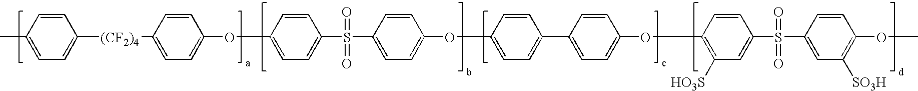

54. The polymer composition of claim 48, wherein if integer “o” equals zero, then integer “m” can equal any one of 3, 4, 5, 7, 8, 9, 10, 11, 12, 13, 14, and 15.

55. The polymer composition of claim 48, wherein said repeat unit includes G and G′, wherein said G attaches to an aromatic ring associated with said P and said G′ attached to an aromatic ring associated with said Q.

56. The polymer composition of claim 55, wherein said G and G′ independently include one member selected from the group consisting of hydrogen, sulfonic acid, phosphoric acid, carboxylic acid, sulfonamide and imidazole.

57. The polymer composition of claim 55, wherein said G and G′ include fluorinated or nonfluorinated aliphatic chains containing one member selected from the group consisting of hydrogen, sulfonic acid, phosphoric acid, carboxylic acid, sulfonamide and imidazole.

58. A process for producing a polymer, comprising combining a plurality of component monomers, at least one of said component monomer has a general structure: 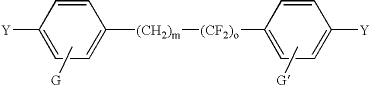
wherein Y is one selected from the group consisting of fluorine, chlorine, bromine, iodine, hydroxyl, carboxylic acid, trimethylsiloxy, nitro and amines;
G and G′ independently is one member selected from the group consisting of hydrogen, sulfonic acids, phosphoric acids, carboxylic acids, sulfonamides and imidazoles; and
m and o being integer values that range between 0 and 15.
